(19) United States
(12) Patent Application Publication
(10) Pub. No.: US 2008/0285586 A1
(43) Pub. Date: Nov. 20, 2008

(54) Multiplexer

(75) Inventors: Stephen Harding, Oldham (GB); Geoff Stokes, Oldham (GB); Richard Robinson, Oldham (GB); David Bradbury, Oldham (GB)

Correspondence Address: JAMES D. STEVENS;REISING, ETHINGTON, BARNES, KISSELLE, P.C., P.O. BOX 4390, TROY, MI, 48099, US

(73) Assignee: ZETEX SEMICONDUCTORS PLC, Chadderton, Oldham (UK)

(21) Appl. No.: 12/092,245

(22) PCT Filed: Oct. 30, 2006
(86) PCT No.: PCT/GB2006/004040

§ 371 Date: Apr. 30, 2008

(30) Foreign Application Priority Data
Nov. 1, 2005 (GB) 0522260.9

(51) Int. Cl. H04J 15/00

(52) U.S. Cl. 370/464

(57) ABSTRACT

A multiplexer (1) having M high frequency input channels (2) and N high frequency output channels (3). The multiplexer (1) comprises N routing control inputs (4); a detector (10) arranged to receive control signals on the or each control input (4), the control signals being indicative of a required connection between the multiplexer input channels (2) and output channels (3); and a decoder (11) arranged to decode the received control signals and generate switching control signals (8) to selectively connect the input channels (2) to the output channels (3) in response to the decoded control signals. The multiplexer (1) is integrated onto a single chip. A multiplexer apparatus comprising a pair of such multiplexers (1) mounted on a printed circuit board is also described. The multiplexers (1) are positioned on opposite sides of the printed circuit board, with one multiplexer (1) rotated 180° about a diagonal axis (20) relative to the other multiplexer (1).

The present invention relates to a multiplexer. In particular, but not exclusively, the present invention relates to a high frequency (HF) multiplexer arranged to selectively connect one or more input channels to one or more output channels.

A multiplexer is arranged to selectively connect input channels to output channels in response to one or more control signals. For instance, a 4:2 multiplexer is arranged to selectively connect 4 input channels to 2 output channels in response to control signals supplied to the multiplexer. The control signals are typically supplied to the multiplexer from external circuitry. There may be any number of input channels and output channels. A multiplexer may be arranged to selectively connect a plurality of input channels to fewer output channels. Alternatively, a multiplexer may be arranged to selectively connect one or more input channels to a greater number of output channels.

Multiplexers are commonly used within computers and other electronic equipment to route signals between different components, for instance over a data bus, to reduce the number of required connections. Multiplexers are also commonly used within communications networks to reduce the number of channels required for long distance communications, thus providing cost savings.

In a multiplexer, it is desirable to be able to connect any selected input channel to any selected output channel. For multiplexers adapted to carry HF signals, it becomes increasingly difficult to maintain isolation between the channels as the frequency increases. If the channels are not properly isolated then cross-talk interference can occur between the channels. Good isolation becomes particularly difficult to achieve for signals at frequencies over 100 MHz, as cross-talk interference becomes increasingly more pervasive as the frequency increases.

Known HF multiplexers typically comprise a plurality of discrete components built onto a printed circuit board. As such, this can present problems when interconnecting the components, due to the signal paths between the components running close to or across one another. This becomes increasingly problematic as the number of signal channels is increased.

It is an object of the present invention to obviate or mitigate one or more of the problems of the prior art, whether identified herein or elsewhere.

According to a first aspect of the present invention there is provided a multiplexer having M high frequency input channels and N high frequency output channels, comprising; N routing control inputs; a detector arranged to receive control signals on the or each control input, the control signals being indicative of a required connection between the multiplexer input channels and output channels; and a decoder arranged to decode the received control signals and generate switching control signals to selectively connect the input channels to the output channels in response to the decoded control signals; wherein the multiplexer is integrated onto a single chip.

An advantage of embodiments of the present invention is that by integrating the detector and the decoder onto a single chip the problem of cross talk interference between channels is reduced. This is because the channel routing requirements for a printed circuit board, on which the multiplexer is mounted, are simplified. By integrating the entire detector/decoder function with a single control pin per channel the PCB design complexity is reduced, providing cost savings. Additionally, this reduces the number of pins required on the multiplexer, reducing the chip, package and board size, again providing cost savings.

Preferably, the multiplexer is adapted to accept input signals on the input channels at frequencies up to 3 GHz and output signals at frequencies up to 3 GHz.

Preferably, the multiplexer is arranged in a package, such that the input channels and the output channels are arranged symmetrically about a diagonal axis of the package. Advantageously, this facilitates stacking two multiplexers on either side of a printed circuit board. One multiplexer may be rotated 180° about the diagonal axis.

Preferably, each input channel is connected to an input buffer switch, each input buffer switch being arranged to connect its associated input channel to one or more output channels in response to the switching control signals.

The input buffer switches may be adapted to disconnect the input channel from the output channels and operate in a power saving mode in response to an appropriate switching control signal. Each input buffer switch may be adapted to amplify input signals on the input channel when not in the power saving mode. Preferably, each input buffer switch is adapted to present an input impedance to the input channel matching the impedance of the input channel.

Preferably, the multiplexer further comprises an interface adapted to receive the switching control signals from the decoder and generate the appropriate analogue voltage levels to drive the transistors within each input buffer stage.

Preferably, the multiplexer further comprises a logic control input, wherein the multiplexer is adapted to alter the selective connection of the input channels to the output channels depending upon a logic control signal received on the logic control input. Changing the state of the logic control signal may reverse the order of connection of the input channels to the output channels.

There may be an even number of input channels. There may be an even number of output channels. There may be four input channels and two output channels.

The control signals may comprise a DC voltage level. The detector may be adapted to detect whether the DC voltage level is above or below a threshold voltage. The detector may be adapted to compare the DC voltage level against a range of threshold values.

The control signals may comprise or further comprise an AC voltage signal. The detector may be adapted to detect whether the AC voltage signal is above or below a threshold amplitude at a predetermined frequency. The predetermined frequency may comprise a predetermined frequency band. The control signals may comprise a plurality of AC voltage signals.

Preferably, the multiplexer further comprises N output stages, each output stage driving an associated output channel. Each input channel may be capable of being connected to every output stage, and each output stage is adapted to drive the associated output channel with an input signal received on one input channel.

Each output stage may comprise at least one output transistor, the current flowing within the or each output transistor being controlled by a low frequency feedback loop by comparing the current within the or each output transistor with a reference current.

Preferably, each output stage is adapted to present an output impedance to the output channel matching the impedance of the output channel.

According to a second aspect of the present invention there is provided a multiplexer apparatus comprising a pair of multiplexers according to claim 3 mounted on a printed circuit board, the multiplexers being positioned on opposite sides of the printed circuit board, with one multiplexer rotated 180° about the diagonal axis relative to the other multiplexer.

The inputs of the pair of multiplexers may be connected together through the printed circuit board forming a multiplexer having M inputs and 2N outputs.

The present invention will now be described, by way of example only, with reference to the accompanying drawings, in which:

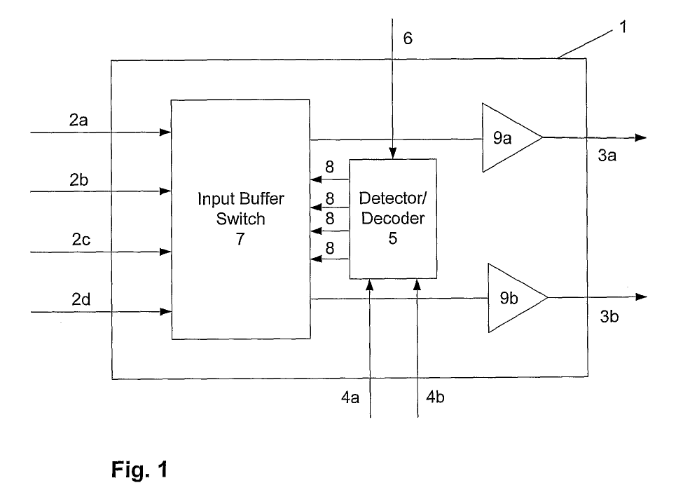

FIG. 1 schematically illustrates a multiplexer in accordance with an embodiment of the present invention;

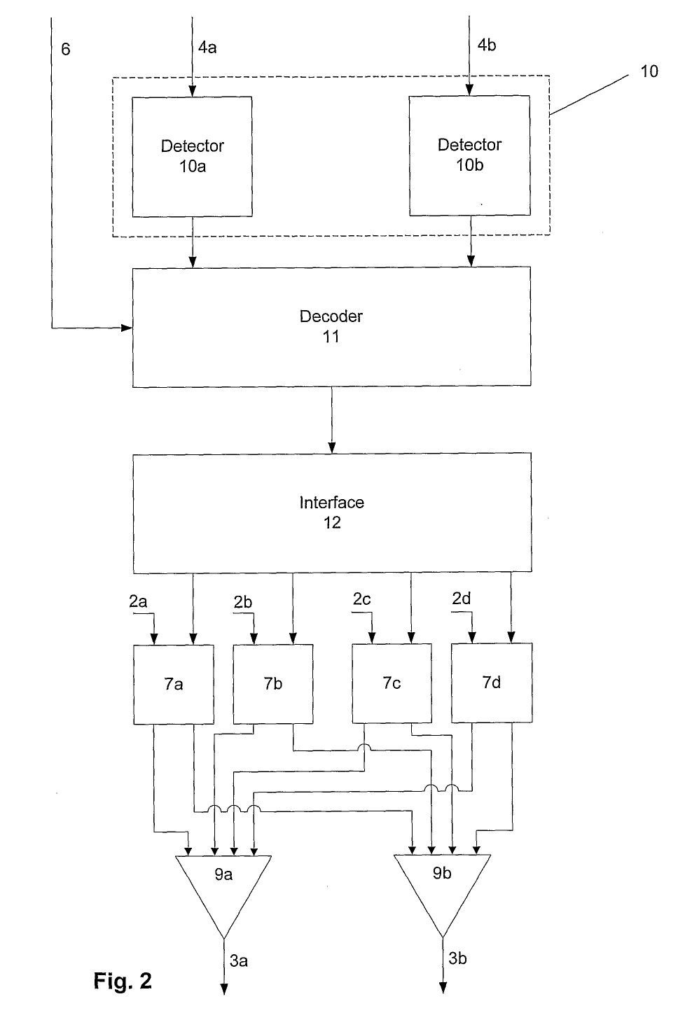

FIG. 2 schematically illustrates part of the multiplexer of FIG. 1; and

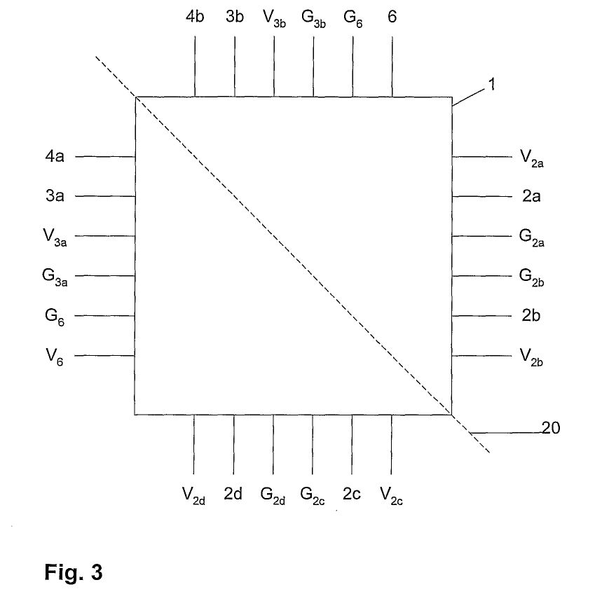

FIG. 3 schematically illustrates the chip package for the multiplexer of FIG. 1.

A critical parameter in the design of HF multiplexers is the isolation between the input and output channels. Cross channel interference can occur as a result of coupling arising within the integrated circuit, in the package in which the integrated circuit is mounted, and due to the way the package is mounted onto a printed circuit board. For multiplexers in accordance with an embodiment of the present invention the isolation between the input and the output channels is maximised. In particular, this is achieved by consideration of the fact that the integrated circuit layout and the choice of package and pin allocation form an important part of the integrated circuit design and should be modelled as a whole up to frequencies where HF instability is no longer a danger. Multiplexers in accordance with an embodiment of the present invention are designed to be functional to 3 GHz. Therefore, modelling of the multiplexer up to around 5 GHz ensures that the multiplexer meets the required device parameters and provides HF stability. Other important parameters include the wide-band gain flatness, input and output impedances and the noise and distortion performance. These parameters may be optimised by designing the multiplexer in accordance with such a multiplexer model.

FIG. 1 shows a 4:2 HF multiplexer in accordance with an embodiment of the present invention fabricated as a single chip. The multiplexer 1 has four HF inputs 2 (indicated respectively as 2a to 2d) and two HF outputs 3 (indicated respectively as 3a and 3b). The multiplexer 1 has two routing control inputs 4 (indicated respectively as 4a and 4b). The routing control inputs 4 provide control signals to a detector/decoder 5. Detector/decoder 5 also has a further logic control input 6. Logic control input 6 allows the logical reversal of the sequence of the HF inputs 2 as explained below.

The detector/decoder 5 is adapted to detect control signals received on the routing control inputs 4 in the form of single or multiple AC frequencies and/or a DC level. These control signals are provided to the multiplexer 1 from external circuitry (not shown), which controls the multiplexer. In the embodiment of the invention shown in FIG. 1, the control signals are provided on the routing control lines 4 as a DC level and/or as an AC frequency.

For instance, the detector/decoder 5 could, for each pin, be adapted to detect a single DC level and a single AC level. If the detected DC level is less than or equal to 14V this corresponds to logic low. If the DC level is greater than or equal to 15V this corresponds to logic high. The AC signal may be measured within a pass band around 22 kHz. If the amplitude of the AC signal is greater than or equal to 300 mVpp this corresponds to logic high. If the amplitude of the AC signal is less than or equal to 100 mVpp this corresponds to logic low.

It will be appreciated by the appropriately skilled person that the decoder/detector 5 may be arranged to simultaneously detect AC signals at or around other frequencies. The detector/decoder 5 may further be arranged to differentiate between a range of DC voltage levels corresponding to different input values. The DC and AC signals that the detector/decoder 5 is arranged to detect may change over time.

In this way, the detector/decoder is able to receive multiple bit control signals based on the absence or presence of a plurality of DC and AC signals on each routing control input 4.

The DC and AC signals supplied to each routing control input 4 may alternatively be referred to as polarisation and tone signals respectively. The HF inputs 2 are received by an input buffer switch 7. Input buffer switch 7 is controlled by switching control signals 8 supplied by the detector/decoder 5 in response to the control signals received on the routing control inputs 4. The switching control signals 8 selectively switch the HF inputs to two output stages 9 (indicated respectively as 9a and 9b). Input buffer switch 7 also pre-amplifies the HF input signals. Output stages 9 provide the output signals on the HF outputs 3.

Only one routing control input 4 is required per HF output channel 3, although additional routing control inputs may be provided. This is because each routing control input 4 carries multiple control signals in the form of DC and AC components. The functionality of the detector/decoder is specific to the intended application of the multiplexer. The example embodiment of FIG. 1 may be simply extended to any number of inputs and outputs. This is because the control signals are externally supplied to each routing control input 4. The decoder may simply be modified to adapt it to other combinations of inputs and outputs.

Other AC signalling methods may also be used, which would require modification of the detector/decoder 5. The present invention is not limited to any particular signalling method. The arrangement of the routing control inputs and signals for FIG. 1 is merely exemplary.

By integrating the detector/decoder 5 with a single routing control input 4 per output channel 3 the PCB design complexity and cost is reduced because no external components are required, saving board space and component cost.

The output stages 9 provide further amplification of the HF output signals and line driving capability so that in typical use there is no requirement for an additional HF line driver external to the multiplexer 1. This obviates the need for further amplifiers on the PCB and therefore reduces the complexity and cost of systems utilising the multiplexer 1.

Referring now to FIG. 2, this illustrates in greater detail the components of the multiplexer. The detector/decoder 5 of FIG. 1 is split into a detector stage 10 and a decoder 11. The detector stage 10 comprises two separate detectors 10a and 10b, each having as an input one of the routing control inputs 4a and 4b. The detectors 10a, 10b detect the control signals on the routing control inputs 4a and 4b respectively and pass the detected control signals to the decoder 11.

Each detector 10a, 10b accepts as an input a combined voltage level and AC signal. Each detector independently checks to see whether the DC level is above or below an application specific threshold (e.g. 14V) and checks whether the AC signal is above or below a certain amplitude and whether it is within an acceptable frequency range (e.g. ≧300 mVpp at 22 kHz). The detectors are also provided with input filters arranged to reject other interfering signals, which may be present.

The detected control signals passed to the decoder 11 from the detectors 10 are digital signals, and may be on multiple control lines. The decoder 11 decodes the control signals to generate the desired truth table. Decoder 11 has as a further input, a logic control input 6. Logic control input 6 serves to reverse the truth table for each output channel 3 such that the input channel 2 selected for each output channel is changed when the logic state of logic control input 6 changes. The truth table for the 4:2 multiplexer of FIGS. 1 and 2 is shown below:

Truth Table, Output Channel 3a

| | | Logic | Input |
|---|---|---|---|
| AC | DC | Control | channel |
| 4a | 4a | Input 6 | selected |
| 1 | 0 | 0 | 2a |
| 0 | 0 | 0 | 2b |
| 0 | 1 | 0 | 2c |
| 1 | 1 | 0 | 2d |
| 1 | 0 | 1 | 2d |
| 0 | 0 | 1 | 2c |
| 0 | 1 | 1 | 2b |
| 1 | 1 | 1 | 2a |

Truth Table, Output Channel 3b

| | | Logic | Input |
|---|---|---|---|
| AC | DC | Control | channel |
| 4b | 4b | Input 6 | selected |
| 1 | 0 | 0 | 2a |
| 0 | 0 | 0 | 2b |
| 0 | 1 | 0 | 2c |
| 1 | 1 | 0 | 2d |
| 1 | 0 | 1 | 2d |
| 0 | 0 | 1 | 2c |
| 0 | 1 | 1 | 2b |
| 1 | 1 | 1 | 2a |

The decoded signals are passed to the interface 12. The interface 12 converts the digital decoded signals to the appropriate analogue levels to drive the analogue switches within the input buffer switch 7. The required analogue drive voltages for the input buffer switch 7 are application specific.

Input buffer switch 7, shown as a single component in FIG. 1, actually comprises a separate input buffer switch (indicated respectively as 7a to 7d) for each HF input 2a to 2d. According to the switching control signals 8 passed to each input buffer switch by the interface, the input buffer switches may pass the HF input signal to either or both of the output stages 9a or 9b. The switching control signals 8 may be passed to each input buffer switch 7 on multiple control lines.

The multiplexer 1 is provided with electrostatic discharge (ESD) protection circuits, to prevent damage occurring to the internal components. The ESD protection circuits are connected to each of the input channels 2, output channels 3, routing control inputs 4 and the logic control input 6.

The input buffer switches 7 are arranged such that they connect the signal on the respective HF input 2 to the first output stage 9a, the second output stage 9b, or neither output stage, as determined by the control signals from the interface 12. When an input buffer switch is arranged not to pass its input to an output stage they can be set into a power saving mode. In the power saving mode, unused portions of the signal circuitry within the input buffer switch are switched into a zero power quiescent setting. This turns off the normal input stage and switched output stages of the input buffer switch 7 and turns on an alternate low power active input stage, which maintains the required input impedance match to the input channel 2.

When an input buffer switch 7 is required to route its input signal to an output stage 9 then an internal preamplifier presents appropriately matched input impedance to the input channel and amplifies the HF signal with an acceptable noise performance. In the embodiment of the present invention shown in FIGS. 1 and 2, the noise performance may be less than or equal to 15 dB. The input impedance of each input buffer switch 7 is chosen to match the characteristics of the connected HF input channel 2 (nominally 50 Ohms).

The amplified input signal is presented to two switching buffer stages (internal to the input buffer switches 7), both, one or neither of which may be activated depending upon the switching control signals 8 received from the interface 12. Each switching buffer stage has an output connected to one of the output stages 9, such that each output stage 9 has an input connected to each of the input buffer switches 7. If the input to the input buffer switch 7 is not to be routed to one or both of the output stages 9 then the signal is blocked by one or both of the switching buffer stages.

The input buffer switches are controlled by the switching control signals 8 received from the interface 12, and thus ultimately controlled by the control signals detected by the detectors 10.

The HF functionality of the multiplexer 1 is designed to be symmetrical about a package diagonal. The multiplexer 1 is arranged such that a pair of multiplexers can be stacked vertically on either side of a PCB to provide a small form factor package for two 4:2 multiplexers. Optionally, the inputs 2 may be electrically connected together through the board. When the inputs 2 are thus connected this provides a 4:4 multiplexer; having the same truth table as for the two devices separately. When they are not so connected this provides two independent 4:2 multiplexers.

The package symmetry is chosen to be about a diagonal so that for a 4:2 multiplexer the two outputs can be on adjacent sides of a quad package and the four inputs on the other pair of adjacent sides. The package isolation contribution is then a maximum as the inputs and the outputs are spaced as far apart as possible. Advantageously, stacking the multiplexers in this way provides for a simple and efficient board layout. The truth table for all four multiplexer output channels is then as shown above for two multiplexers. Since the devices on opposite sides of the PCB are flipped relative to one another, the same sequence of the inputs is restored by choosing opposite logical states for the logic control inputs 6. The truth table (where 3x_1, 4x_1 and 3x_2, 4x_2 refer respectively to opposite sides of the PCB) could then be:

Truth Table, Output Channel 3a_1

| | | Logic | Input |
|---|---|---|---|
| AC | DC | Control | channel |
| 4a_1 | 4a_1 | Input 6 | selected |
| 1 | 0 | 0 | 2a |
| 0 | 0 | 0 | 2b |
| 0 | 1 | 0 | 2c |
| 1 | 1 | 0 | 2d |

Truth Table, Output Channel 3a_2

| | | Logic | Input |
|---|---|---|---|
| AC | DC | Control | channel |
| 4a_2 | 4a_2 | Input 6 | selected |
| 1 | 0 | 1 | 2a |
| 0 | 0 | 1 | 2b |
| 0 | 1 | 1 | 2c |
| 1 | 1 | 1 | 2d |

Truth Table, Output Channel 3b_1

| | | Logic | Input |
|---|---|---|---|
| AC | DC | Control | channel |
| 4b_1 | 4b_1 | Input 6 | selected |
| 1 | 0 | 0 | 2a |
| 0 | 0 | 0 | 2b |
| 0 | 1 | 0 | 2c |
| 1 | 1 | 0 | 2d |

Truth Table, Output Channel 3b_2

| | | Logic | Input |
|---|---|---|---|
| AC | DC | Control | channel |
| 4b_2 | 4b_2 | Input 6 | selected |
| 1 | 0 | 1 | 2a |
| 0 | 0 | 1 | 2b |
| 0 | 1 | 1 | 2c |
| 1 | 1 | 1 | 2d |

The outputs do not have to be symmetrically arranged since they are used independently of one another. In the present example since there are two outputs they are symmetrical in the optimum pin arrangement.

The output stages 9 are always active. That is, each output stage 9 is always driven by a selected input buffer switch 7. Each output stage accepts a signal from the active one of the four input buffer switches 7 and drives the output load connected to the output channel 3 with an appropriately matched output impedance (in the present example nominally 75 ohms) and low distortion (in the present example typically the third order distortion (IP3) is about 16 dBm).

The current in the output transistors within the output stages 9 is controlled by a low frequency feedback loop. The low frequency feedback loop forces the actual current to the desired level by comparison with a reference current. This allows operation with relatively poorly regulated supply voltages. The performance of the output stages in the pass band is determined by negative feedback, which also provides a controlled input impedance for each output stage 9 as seen by the output of the input buffer switches 7. This reduces the interdependence of the input buffer switches 7 and the output stages 9.

Referring now to FIG. 3, this schematically illustrates the arrangement of the input and output package pins for an implementation of the multiplexer shown in FIGS. 1 and 2. Corresponding inputs and outputs are referred to using the same reference numerals. The inputs and outputs are arranged symmetrically about a diagonal axis 20 of the multiplexer 1. This is to ensure that two multiplexers can be stacked on opposite sides of a PCB by flipping one multiplexer 1800 about the diagonal axis 20. By doing this, the inputs 2 and outputs 3 line up correctly, such that if required the inputs may be connected together through the PCB. By ensuring that the logic control input 6 on a first multiplexer is at a different logic state to that of a second multiplexer, the inputs that are routed to the outputs are reversed on one of the multiplexers. This means that the inputs can be connected together and still ensure the correct functioning of each multiplexer.

Along the right hand side and bottom side of multiplexer 1 are the input channels 2a to 2d. Associated with each input channel 2 there are corresponding voltage ground and voltage supplies (indicated respectively as G₂ₐ and V₂ₐ for instance). These voltage supplies and ground connections provide the power supply to each of the input buffer switches 7 associated with each input channel 2. The control inputs 4a and 4b are on the left hand side and the top side respectively, mirrored about the diagonal axis 20. Logic control input 6 is shown on the top side. Voltage supply V₆ on the left side and the ground connection G₆ provide a voltage supply to the detector 10, decoder 11 and interface 12. The output channels 3a, 3b and the corresponding voltage ground and voltage supplies (indicated respectively as G₃ₐ and V₃ₐ for instance) are on the left hand side and the top side respectively, again mirrored about the diagonal axis 20.

Although in the embodiment of the invention described above the multiplexer is described as a 4:2 multiplexer, it will be readily apparent to the appropriately skilled person that there may be any number of inputs and outputs. For embodiments of the present invention in which two multiplexers are stacked vertically with connected inputs (one device with inputs reversed) the inputs must be symmetrically arranged and therefore must be in multiples of two. Otherwise the number of inputs and outputs are only limited by packaging considerations.

Other modifications and applications of the present invention will be readily apparent to the appropriately skilled person from the teaching herein, without departing from the scope of the appended claims.

1. A multiplexer having M high frequency input channels and N high frequency output channels, comprising;
N routing control inputs;
a detector arranged to receive control signals on the control inputs, the control signals being indicative of a required connection between the multiplexer input channels and output channels; and
a decoder arranged to decode the received control signals and generate switching control signals to selectively connect the input channels to the output channels in response to the decoded control signals;
wherein the multiplexer is integrated onto a single chip.

2. A multiplexer according to claim 1, wherein the multiplexer is adapted to accept input signals on the input channels at frequencies up to 3 GHz and output signals at frequencies up to 3 GHz.

3. A multiplexer according to claim 1, wherein the multiplexer is arranged in a package, such that the input channels and the output channels are arranged symmetrically about a diagonal axis of the package.

4. A multiplexer according to claim 1, wherein each input channel is connected to an input buffer switch, each input buffer switch being arranged to connect its associated input channel to one or more output channels in response to the switching control signals.

5. A multiplexer according to claim 4, wherein the input buffer switches are adapted to disconnect the input channel from the output channels and operate in a power saving mode in response to an appropriate switching control signal.

6. A multiplexer according to claim 5, wherein each input buffer switch is adapted to amplify input signals on the input channel when not in the power saving mode.

7. A multiplexer according to claim 4, wherein each input buffer switch is adapted to present an input impedance to the input channel matching the impedance of the input channel.

8. A multiplexer according to claim 4, further comprising an interface adapted to receive the switching control signals from the decoder and generate the appropriate analogue voltage levels to drive the transistors within each input buffer stage.

9. A multiplexer according to claim 1, further comprising a logic control input, wherein the multiplexer is adapted to alter the selective connection of the input channels to the output channels depending upon a logic control signal received on the logic control input.

10. A multiplexer according to claim 9, wherein changing the state of the logic control signal reverses the order of connection of the input channels to the output channels.

11. A multiplexer according to claim 1, wherein there is an even number of input channels.

12. A multiplexer according to claim 1, wherein there is an even number of output channels.

13. A multiplexer according to claim 1, wherein there are four input channels and two output channels.

14. A multiplexer according to claim 1, wherein the control signals comprise a DC voltage level.

15. A multiplexer according to claim 14, wherein the detector is adapted to detect whether the DC voltage level is above or below a threshold voltage.

16. A multiplexer according to claim 14, wherein the detector is adapted to compare the DC voltage level against a range of threshold values.

17. A multiplexer according to claim 1, wherein the control signals comprise or further comprise an AC voltage signal.

18. A multiplexer according to claim 17, wherein the detector is adapted to detect whether the AC voltage signal is above or below a threshold amplitude at a predetermined frequency.

19. A multiplexer according to claim 18, wherein the predetermined frequency comprises a predetermined frequency band.

20. A multiplexer according to claim 17, wherein the control signals comprise a plurality of AC voltage signals.

21. A multiplexer according to claim 1, further comprising N output stages, each output stage driving an associated output channel.

22. A multiplexer according to claim 21, wherein each input channel is capable of being connected to every output stage, and each output stage is adapted to drive the associated output channel with an input signal received on one input channel.

23. A multiplexer according to claim 21, wherein each output stage comprises at least one output transistor, the current flowing within the one or more output transistors being controlled by a low frequency feedback loop by comparing the current with a reference current.

24. A multiplexer according to claim 21, wherein each output stage is adapted to present an output impedance to the output channel matching the impedance of the output channel.

25. A multiplexer apparatus comprising a pair of multiplexers according to claim 3 mounted on a printed circuit board, the multiplexers being positioned on opposite sides of the printed circuit board, with one multiplexer rotated 180° about the diagonal axis relative to the other multiplexer.

26. A multiplexer apparatus according to claim 25, wherein the inputs of the pair of multiplexers are connected together through the printed circuit board forming a multiplexer having M inputs and 2N outputs.

27-28. (canceled)
